(19) United States
(12) Patent Application Publication
(10) Pub. No.: US 2026/0210704 A1
(43) Pub. Date: Jul. 23, 2026

(54) METHOD FOR INSPECTING SEMICONDUCTOR DEVICE AND SYSTEM THEREOF

(71) Applicant: TAIWAN SEMICONDUCTOR MANUFACTURING COMPANY LTD., HSINCHU (TW)

(72) Inventors: YI-ZHEN CHEN, HSINCHU (TW); SHANG-CHIEH CHIEN, NEW TAIPEI CITY (TW); LI-JUI CHEN, HSINCHU CITY (TW)

(21) Appl. No.: 19/032,136

(22) Filed: Jan. 20, 2025

(51) Int. Cl. G01B 11/27; G01N 21/88; G01N 21/95

(52) U.S. Cl. CPC G01B 11/272; G01N 21/8851; G01N 21/9501; G01N 2201/025

(57) ABSTRACT

An inspection system and inspection methods are provided. The inspection method includes steps of placing an specimen on a stage, wherein the stage comprises a plurality of first alignment marks; capturing a first image of the first alignment marks; determining a position drift between a current position of the stage and a reference position of the stage based on the first image; compensating for the position drift between the current position of the stage and the reference position of the stage; and performing an inspection operation on the specimen in response to the position drift being less than a first tolerance.

### BACKGROUND

Fabrication of semiconductor devices, such as logic and memory devices, typically includes processing a substrate, such as a semiconductor wafer, using a large number of semiconductor fabrication processes to form various features and multiple levels of the semiconductor devices. For example, photolithography is a semiconductor fabrication process that involves transferring a pattern from a reticle to a photoresist arranged on a semiconductor wafer.

Inspection processes are used at various steps during semiconductor manufacturing processes to detect defects on wafers or reticles and promote higher yield in the manufacturing process and thus increase profits.

### BRIEF DESCRIPTION OF THE DRAWINGS

Aspects of the present disclosure are best understood from the following detailed description when read with the accompanying figures. It should be noted that, in accordance with standard practice in the industry, various features are not drawn to scale. In fact, dimensions of the various features may be arbitrarily increased or reduced for clarity of discussion.

FIG. 1 is a schematic diagram of an inspection system, in accordance with some embodiments of the present disclosure.

FIG. 2 is a schematic diagram of a stage and a reticle, in accordance with some embodiments of the present disclosure.

FIG. 3 is a schematic top view showing various arrangements of alignment marks on a stage, in accordance with some embodiments of the present disclosure.

FIGS. 4a to 4c are schematic top views showing various alignment marks, in accordance with some embodiments of the present disclosure.

FIG. 5 is a flowchart of a method of inspecting a reticle, in accordance with some embodiments of the present disclosure.

FIG. 6 is a schematic block diagram of generating a predicted alignment offset, a measured alignment offset, and a final alignment offset during a fine alignment operation in accordance with some embodiments of the present disclosure.

FIG. 7 is a schematic block diagram of training a prediction model, in accordance with some embodiments of the present disclosure.

FIG. 8 is a flowchart of a method of determining a position drift is an acceptable position drift, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features are not in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first,” “second” and “third” describe various elements, components, regions, layers and/or sections, but these elements, components, regions, layers and/or sections should not be limited by these terms. These terms may be only used to distinguish one element, component, region, layer or section from another. The terms such as “first,” “second” and “third” when used herein do not imply a sequence, order, or importance unless clearly indicated by the context.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the normal deviation found in the respective testing measurements. Also, as used herein, the terms “substantially,” “approximately” or “about” generally mean within a value or range (e.g., within 10%, 5%, 1%, or 0.5% of a given value or range) that can be contemplated by people having ordinary skill in the art. Alternatively, the terms “substantially,” “approximately” or “about” mean within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of time, temperatures, operating conditions, ratios of amounts, and the likes thereof disclosed herein should be understood as modified in all instances by the terms “substantially,” “approximately” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another end point or between two endpoints. All ranges disclosed herein are inclusive of the endpoints, unless specified otherwise.

The present disclosure is directed to an inspection system that includes a stage with alignment marks. The inspection system is configured to detect defects on a specimen, such as a semiconductor device (e.g., a reticle). The alignment marks are disposed on a front surface of the stage and used for measuring a position drift of the stage, calibrating the position drifting of the stage, and monitoring a health status of the stage based on the position drift.

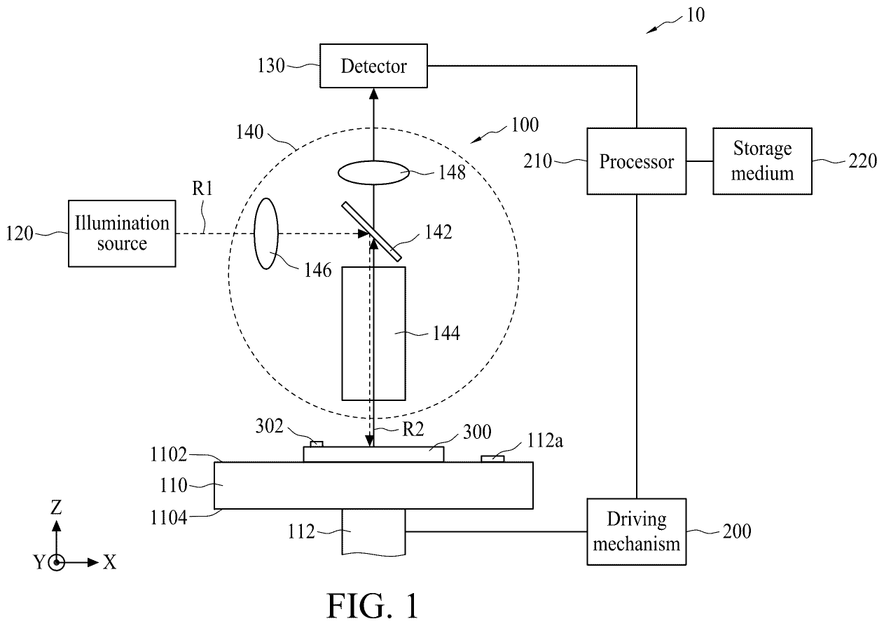

FIG. 1 is a schematic block diagram of an inspection system 10, in accordance with some embodiments of the present disclosure. Referring to FIG. 1, the inspection system 10 is configured to inspect a specimen 300 of interest. For example, the specimen 300 may be a reticle (also referred to as a photomask or a mask). The reticle has a desired pattern and is used during photolithography operations to transfer the pattern onto multiple semiconductor substrates. Accordingly, any defects on the reticle will be transferred to the semiconductor substrates and thus, cause yield issues. The defects may include particle contamination and structural defects due to repeated use of the reticle (for example, through repeated photolithography operations). The structural defects may include excessive corner rounding, unsatisfactory dimensions, missing of extra features of the pattern, bridging between separate features of the pattern, etc.

The inspection system 100 is configured to perform an inspection operation to determine whether the reticle includes any defects. If any defects are detected, the reticle may be cleaned or the pattern of the reticle may be modified or repaired depending on the type of defect detected. The inspection of the reticle may be a periodic inspection or an event-based inspection. The event-based inspection may be performed based on a triggering event, such as multiple semiconductor substrates with the same defect(s) being produced. In the present disclosure, the inspection system 100 is configured to inspect a reflective reticle used in a deep ultraviolet (DUV) photolithography tool or an extreme ultraviolet (EUV) photolithography tool.

In some embodiments, the inspection system 10 includes an inspection tool 100, a driving mechanism 200, a processor 210, and a storage medium 220. The inspection tool 100 may include a stage 110, an illumination source 120, a detector 130, and a lens assembly 140. The stage 110 is configured to secure and move the specimen 300. The stage 110 may include a front surface 1102 and a back surface 1104 opposite to the front surface 1102. The specimen 300 is, for example, disposed on the front surface 1102 of the stage 110. In some embodiments, the stage 110 is coupled to the driving mechanism 200, and the driving mechanism 200 is coupled to the processor 210. The driving mechanism 200 is configured to implement a movement of the stage 110 based on instructions from the processor 210. For example, the driving mechanism 200 is configured to move the stage 110 in a direction of one or more axes. The stage 110 may be moved along each of the X, Y, and Z coordinates according to instructions from the processor 210.

The illumination source 120 is configured to generate a radiation R1 for inspection. The radiation R1 may be used to illuminate the specimen 300 and the stage 110. The radiation R1 may be visible radiation or invisible radiation. The illumination source 120 may generate the radiation R1 at a wavelength which corresponds to an operating wavelength of a photolithography tool in which the specimen 300 is used. For example, in embodiments where the specimen 300 is a reflective reticle used in the EUV photolithography tool, the illumination source 120 is designated for generating EUV radiation.

The detector 130 is disposed above the stage 110 and configured to detect radiation R2 from the specimen 300 and the stage 110 and to generate an output in respond to the detected radiation R2. In some embodiments, the detector 130 is a two-dimensional detector, resulting in an area scan camera. The detector 130 may include a charge-coupled device. The detector 130 may have a field of view, which refers to a total area that the detector 130 is capable of viewing in three dimensions. In some embodiments, during the inspection, the specimen 300 and the stage 110 are positioned within the field of view of the detector 130. The detector 130 may include a time delay integration camera. In some embodiments, the detector 130 is sensitive to a wavelength of the radiation R1 generated by the illumination source 120.

In some embodiments, the detector 130 is coupled to the processor 210. The processor 210 may be configured to detect defects on the specimen 300 using detection data collected and transmitted by the detector 130. The processor 210 may utilize any method and/or algorithm to detect defects on the specimen 300. The processor 210 is configured to execute instructions for carrying out an inspection method according to some embodiments of the disclosure. The processor 210 is, for example, a central processing unit (CPU), another programmable general-purpose or specific-purpose microprocessor, a digital signal processor (DSP), a programmable controller, an application specific integrated circuit (ASIC), a programmable logic device (PLD), another similar device, or a combination thereof, but the disclosure is not limited thereto. The processor 210 is coupled to the detector 130 in any suitable manner such that the processor 210 can receive the output generated by the detector 130. The storage medium 220 is coupled to the processor 210. In some embodiments, the storage medium 220 is configured to store data for the processor 210. For example, the storage medium 220 may be configured to store inspection images generated by the inspection of the specimen 300.

The lens assembly 140 is arranged to direct the radiation R1 from the illumination source 120 to the specimen 300 and the stage 110 and to direct the radiation R2 from the specimen 300 and the stage 110 to the detector 130. In some embodiments, the lens assembly 140 includes an optical splitter 142, one or more objective lenses 144, a first relay lens 146, and a second relay lens 148. In some embodiments, the optical splitter 142 changes a travelling direction of the radiation R1. The illumination source 120 may emit the radiation R1 in a horizontal direction (e.g., the X-direction) toward the optical splitter 142. The optical splitter 142 is configured to reflect the radiation R1 at a substantially normal angle of incidence (e.g., about 90 degrees), thereby directing the radiation R1 through the objective lens 144 to the specimen 300 and the stage 110. Some of the radiation R1 is scattered by the specimen 300 and the stage 110, other portions of the radiation R1 are reflected back into the objective lens 144 by the specimen 300 and the stage 110, forming a reflective radiation R2. The reflective radiation R2 travels through the objective lens 144 and the optical splitter 142 and to the detector 130. In some embodiments, the optical splitter 142 is a polarizing beam splitter, which reflects radiation in one orientation of polarization while radiation in the orthogonal polarization state passes therethrough.

The radiation R1 that reaches the specimen 300 and the stage 110 may have a spot size (not shown). The spot size of the radiation R1 may be substantially a size of the stage 110. Thus, it is possible to illuminate the entire specimen 300 and the stage 110, resulting in an inspection image that is a correct representation of characteristics of the specimen 300 and the stage 110. The first relay lens 146 is arranged between the illumination source 110 and the optical splitter 142, and the objective lens 144 is arranged between the optical splitter 142 and the specimen 300. The first relay lens 146 may define the spot size of the radiation R1 in conjunction with the objective lens 144. The second relay lens 148 is arranged between the optical splitter 132 and the detector 130. The second relay lens 148 may define an image magnification ratio in conjunction with the objective lens 144.

During an inspection operation, accurate alignment between the specimen 300 and the detector 130 can reduce detection errors caused by alignment errors. The specimen 300 is provided with one or more alignment marks 302. The alignment marks 302 may be used to indicate relative positions of a pattern of the specimen 300. In an existing example, the specimen 300 and the detector 130 may be aligned based on the alignment marks 302 on the specimen 300. For example, before the inspection of the specimen 300, an alignment operation is performed, during which the detector 130 acquires alignment data that includes positions of the alignment marks 302 of the specimen 300. The processor 210 then receives the alignment data in response to the alignment operation. The processor 210 may be configured to determine whether the specimen 300 is aligned sufficiently well, e.g., within a determined tolerance, based on the alignment data. If the specimen 300 is aligned sufficiently well, the inspection operation is performed to detect defects on the specimen 300. If the specimen 300 is considered to be misaligned with the detector 130, the processor 210 may generate instructions for calibrating the position of the stage 110 and transmit the instructions to the driving mechanism 200. The driving mechanism 200 is configured to move the stage 110, and thus the specimen 300, toward a target position according to the instructions.

A measurement operation of the specimen 300 may be used to reduce or eliminate an inspection failures caused by a mapping error and a focus error due to the specimen 300. The mapping error may refer to an alignment error in the X-direction, and/or an alignment error in the Y-direction between the specimen 300 and the target position. The mapping error may refer to an alignment errors in a horizontal plane, e.g., X-Y plane.

The mapping error may be introduced by placement of the specimen 300 in positions different from a target X-direction or Y-direction. The focus error may refer to alignment errors in the Z-direction between the specimen 300 and the target position. The focus error may be introduced by placement of the specimen 300 in positions in the Z-direction different.

Systematic errors contributed by the stage 110 cannot be tracked during the alignment of the alignment marks 302 of the specimen 300 with the detector 130. When the inspection system 10 undergoes repeated use, the stage 110 is subject to aging, and the stage 110 may experience a position drift. The position drift of the stage 110 may be a displacement of the stage 110 relative to a reference position. The position drift of the stage 110 compromises a precision and an accuracy of inspection. The position drift of the stage 110 may include drifts in the X-direction, Y-direction, and/or Z-direction. The position drift of the stage 110 may affect a quality of the image used for determining whether any defects are present on the specimen 300. It is therefore desirable to form alignment marks on the stage 110 to evaluate conditions of the stage 110 and calibrate the position drift of the stage 110 if necessary.

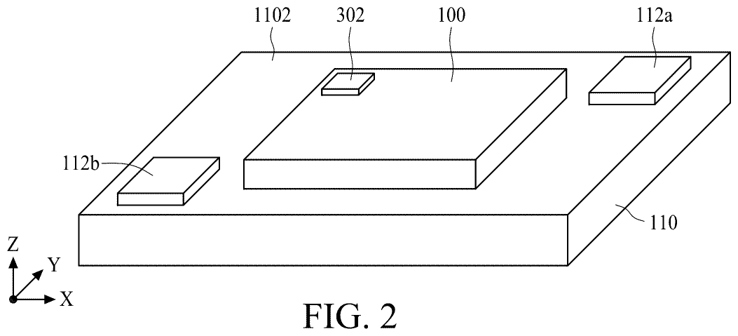

FIG. 2 is a schematic diagram of the specimen 300 and the stage 110, in accordance with some embodiments of the present disclosure. Referring to FIGS. 1 and 2, the stage 110 includes a plurality of alignment marks 112a and 112b disposed on the front surface 1102 of the stage 110. The alignment marks 112a and 112b are used for monitoring alignment conditions for the stage 110. The alignment marks 112a and 112b may be used to monitor the status and/or the remaining life time of the stage 110. The alignment marks 112a and 112b include one or more materials that are configured to reflect the radiation R1 from the illumination source 120. The alignment marks 112a and 112b may have a reflective material same as that of the specimen 300. For example, the alignment marks 112a and 112b may include molybdenum (Mo) and silicon (Si). In some embodiments, the alignment marks 112a and 112b and the specimen 300 have the same film stake. For example, the alignment marks 112a and 112b may include a reflective multilayer and an absorber layer on the reflective multilayer.

The stage 110 may have a square shape from a top-view perspective. In some embodiments, the specimen 300 is located at a central region of the stage 110, and the alignment marks 112a and 112b are diagonally disposed with respect to each other from a top-view perspective. For example, the alignment mark 200a is disposed diagonally adjacent to a top-right corner of the stage 110, and the alignment mark 112b is disposed diagonally adjacent to a bottom-left corner of the stage 110.

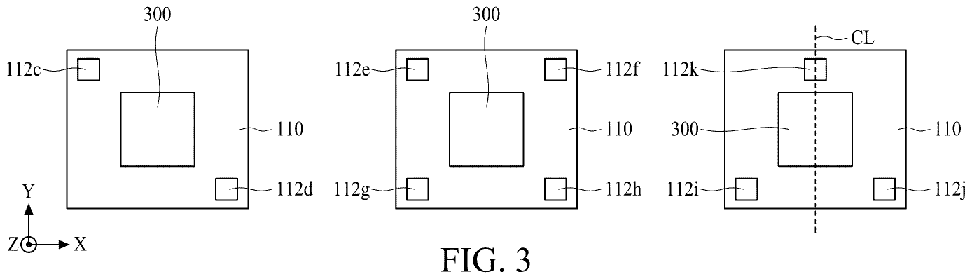

Various arrangements of alignment marks may be designed according to specific requirements of the stage 110. FIG. 3 shows schematic top views of various arrangements of the alignment marks 112c to 112k on the stage 110, in accordance with some embodiments of the present disclosure. Referring to a left subfigure of FIG. 3, in some embodiments, the stage 110 includes two alignment marks 112c and 112d arranged diagonally from a top view perspective. The specimen 300 is located at a central region of the stage 110. The alignment mark 112c is disposed adjacent to a top-left corner of the stage 110, and the alignment mark 112d is disposed adjacent to a bottom-right corner of the stage 110.

Referring to a middle subfigure of FIG. 3, the stage 110 includes four alignment marks 112e to 112h around the specimen 300 located at a central region of the stage 110 from a top-view perspective. The alignment marks 112e to 112h may each be disposed diagonally adjacent to a respective corner of the stage 110. The alignment marks 112e to 112h are positioned diagonally in each corner of the stage 110. For example, the alignment mark 112e is disposed adjacent to the top-left corner of the stage 110, the alignment mark 112f is disposed adjacent to the top-right corner of the stage 110, the alignment mark 112g is disposed adjacent to the bottom-left corner of the stage 110, and the alignment mark 112h is disposed adjacent to the bottom-right corner of the stage 110.

Referring to a right subfigure of FIG. 3, the stage 110 includes three alignment marks 112i to 112k. In a top-view perspective, the specimen 300 and the alignment marks 112i to 112k may be symmetrical with respect to a hypothetic center line CL extending in the Y-direction. The specimen 300 is, for example, located in a central region of the stage 110. The alignment mark 112i is disposed adjacent to the bottom-left corner of the stage 110, and the alignment mark 112j is disposed adjacent to the bottom-right corner of the stage 110. The alignment mark 112k may be disposed at a top middle location of the stage 110, and the center line CL crosses the alignment mark 112k.

The arrangements of the alignment marks 112a to 112k shown in FIG. 2 and FIG. 3 are provided for illustrative purposes. Other arrangements or shapes of the alignment marks are also within the contemplated scope of the present disclosure.

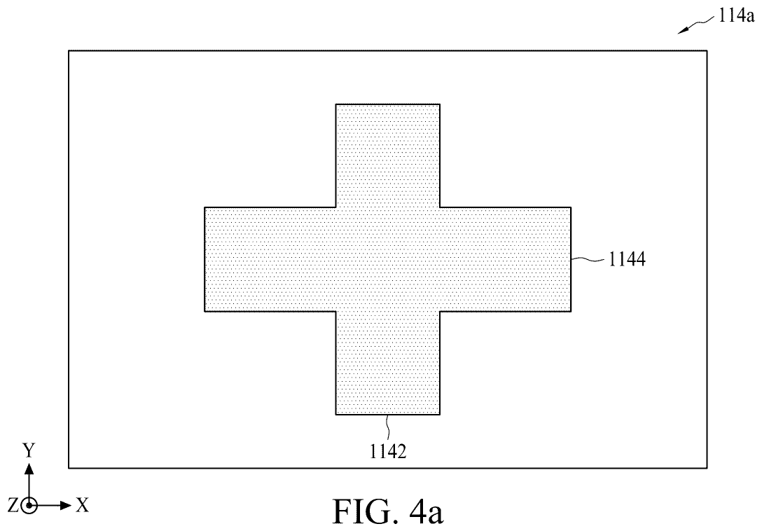

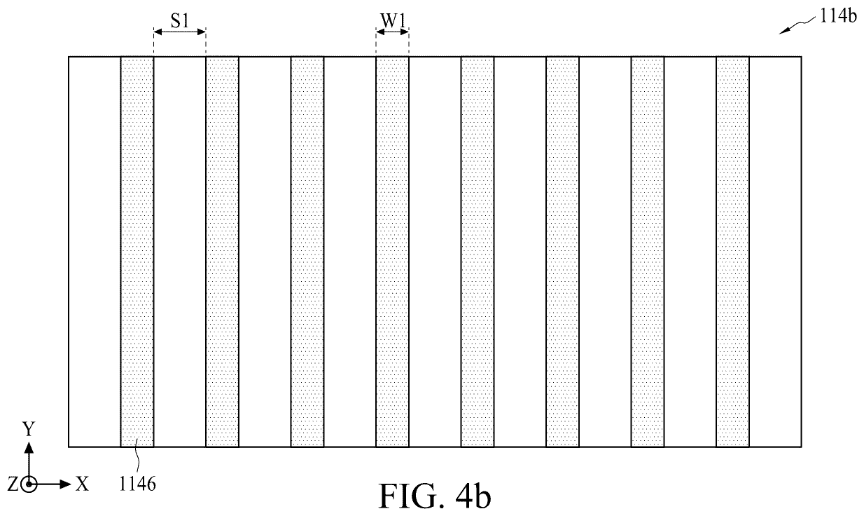

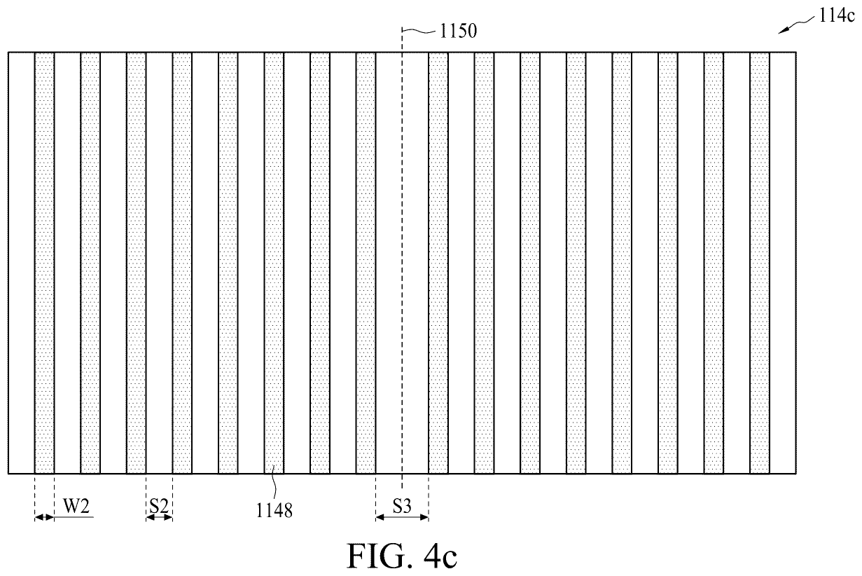

FIGS. 4a to 4c are schematic top views showing patterns 114a to 114c of the alignment marks 112a to 112k shown in FIGS. 2 and 3, in accordance with some embodiments of the present disclosure. The alignment marks 112a to 112k are designed to be capable of catching the alignment errors of the stage 110 with higher sensitivity. Referring to FIG. 4a, the pattern 114a can be viewed as a combination of two rectangles 1142 and 1144. The two rectangles 1142 and 1144 are oriented in different orientations, e.g., one is oriented in the direction of an X-axis (i.e., an axis along the X-direction), while the other is oriented in the direction of a Y-axis (i.e., an axis along the Y-direction). The pattern 114a may have a cross shape. The two rectangles 1142 and 1144 cross each other and their centers overlap each other to form the pattern 114a. The pattern 114a may be used for measuring mapping error.

Referring to FIG. 4b, in some embodiments, the pattern 114b includes a plurality of rectangles, strips or bars 1146 in a periodic pattern. The rectangles 1146 may be arranged at regularly spaced intervals. The rectangles 1146 are formed in a line-and-space arrangement extending in one direction (e.g., the Y-direction) with a constant spacing S1. The spacing S1 is a distance from one rectangle 1146 to an adjacent rectangle 1146, and the spacing S1 may be defined from an edge of one of the rectangle 1146 to a corresponding edge of the adjacent rectangle 1146. Each rectangle 1146 is separated from an adjacent rectangle 1146 by the spacing S1. The rectangles 1146 may have a constant line width W1. The line width W1 of the rectangles 1146 may be, for example, less than the spacing S1. The pattern 114b may be used for detecting the focus error.

Referring to FIG. 4c, the pattern 114c may include a plurality of rectangles 1148 extending in one direction (e.g., the Y-direction). The rectangles 1148 may have a uniform width W2. In some embodiments, the rectangles 1148 have multiple spacing S2 and spacing S3, wherein the spacing S3 is greater than spacing S2. For example, one of the rectangles 1148 closest to a hypothetic center line 1150 of the pattern 114c is spaced apart from an adjacent rectangle 1148 by the spacing S3, and the other rectangles 1148 are spaced apart from corresponding adjacent rectangles 1148 by the spacing S2. The pattern 114c may be symmetrical about the hypothetic center line 1150. The pattern 114c may be used for detecting the focus error. In embodiments where the stage 110 includes two alignment marks, one of the alignment marks has the pattern 114a, and the other alignment mark has the pattern 114b or 114c. In embodiments where the stage 110 includes more than two alignment marks, it is required to have an alignment mark with the pattern 114a for detecting the mapping error. The stage 110 may include one or more alignment marks with the pattern 114b or 114c for the detecting focus error.

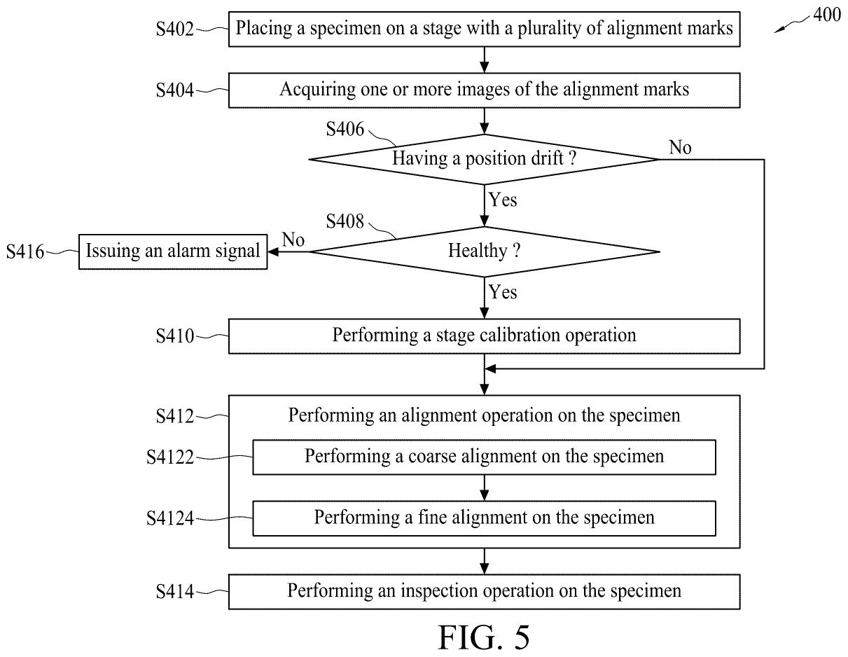

FIG. 5 is a flowchart of a method 400 of inspecting a specimen, in accordance with some embodiments of the present disclosure. The method 400 includes a step S402 of placing a specimen on a stage with a plurality of alignment marks, a step S404 of acquiring one or more alignment images of the alignment marks, a step S406 of determining whether the stage has a position drift, a step S408 of determining a health status of the stage of the stage having the position drift, a step S410 of performing a stage calibration operation if the stage is healthy, a step S412 of performing an alignment operation on the specimen, a step S414 of performing an inspection operation on the specimen, and a step S416 of issuing an alarm signal if the stage is unhealthy.

The following describes the method 400 using the above-mentioned inspection system 10. In particular, the inspection system 10 includes an inspection tool 100, a driving mechanism 200, a processor 210, and a storage medium 220. The inspection tool 100 may include a stage 112 and a detector 130 disposed over the stage 112. The processor 210 is coupled to the driving mechanism 200, the storage medium 220. The inspection tool 100 may include a stage 110 and a detector 130, wherein the stage 110 is coupled to the driving mechanism 200, and the detector 130 is coupled to the processor 210.

Referring to FIGS. 1, 2 and 5, the method 400 begins at step S402, in which a specimen 300 is placed on the stage 110. The inspection system 110 may be configured to detect whether defects are present on the specimen 300. The stage 110 is configured to secure and move the specimen 300. The stage 112 includes two or more alignment marks such as the alignment marks 212a and 212b shown in FIG. 2. One of the alignment marks 212a and 212b has a cross-shaped pattern (e.g., the pattern 114a shown in FIG. 4a) for detecting the mapping error. The other alignment mark 212a or 212b may have a line-and-space pattern (e.g., the pattern 114b shown in FIG. 4b or the pattern 114c shown in FIG. 4c) for detecting focus error.

The method 400 then proceeds to step S404, in which one or more alignment images of the alignment marks 212a and 212b are acquired. The alignment images show a pattern of the alignment marks 112a and 112b on the stage 110. The alignment images may be acquired by the detector 130. In some embodiments, each of the alignment images shows the alignment marks 112a and 112b. During the acquisition of the alignment images, the stage 110, the alignment marks 112a and 112b, and the specimen 300 are illuminated by an illumination source 110 of the inspection tool 100. The detector 130 may collect radiation reflected by the stage 110, the alignment marks 112a and 112b, and the specimen 300 and generate an alignment image in accordance with the radiation reflected by the stage 110, the alignment marks 112a and 112b, and the specimen 300. Therefore, each of the alignment images may further include the specimen 300 and portions of the stage 110 exposed through the specimen 300 and the alignment marks 112a and 112b.

In alternative embodiments, each of the alignment images shows one of the alignment marks 112a and 112b on the stage 110. The use of alignment images showing only limited portions of the stage 110 (i.e., the alignment mark 112a or 112b) may help to reduce complexity associated with processing the alignment images, as described below. During the acquisition of the alignment images, the illumination source 110 of the inspection tool 100 is configured to illuminate the alignment marks 112a and 112b, and the detector 130 is configured to collect radiation reflected from the alignment marks 112a and 112b to generate the alignment images.

Subsequently, the method 400 proceeds to a determination step S406. In step S406, it is determined whether the stage 110 has a position drift. In some embodiments, an image processing algorithm is applied to the alignment images in order to locate a current position of the stage 110 and calculate a drift distribution of the stage 110. The image processing algorithm may be implemented in the processor 210. The current position of the stage 110 is a three-dimensional position.

The drift distribution may include a position shift in the X-direction, a position shift in the Y-direction, and a position shift in the Z-direction. In some embodiments, the image processing algorithm may compare the alignment images with corresponding reference images to determine whether the stage 110 has the position drift. The reference images may be stored in the storage medium 220. The reference images may include a set of images of a reference stage without any position drift. The images of the reference stage may be generated by simulating an inspection operation on the stage 110 with the alignment marks 112a and 112b. In other words, the images of the reference stage may be simulated images. The image of the reference stage without position drift may be the images acquired using previously-determined position information of the stage 110.

The position shift in the X-direction and/or the Y-direction is related to a mapping error. Each alignment image may be compared to a corresponding reference image, for example on a pixel-by-pixel basis, to determine the position shift in the X-direction and the Y-direction. The position shift in the Z-direction is related to the focus error. The position shift in the Z-direction may be determined by a degree of blurring of each alignment image when the alignment image being out of focus. The position shift in each of the X-direction, the Y-direction, or the Z-direction may be referred as to a linear displacement.

In some embodiments, the position shift in the X-direction, the position shift in the Y-direction, and the position shift in Z-direction of each of the alignment images may be used to identify a presence of expansion errors. The expansion errors may include the position shift in the X-direction, the Y-direction, or the Z-direction due to thermal expansion mismatch.

In some embodiments, the position shift in the X-direction, the position shift in the Y-direction, and the position shift in Z-direction of each alignment image may be used to identify a presence of tilt errors or tilt displacement of the stage 110. The tilt errors may be expressed by a degree of rotation about an axis along the X-direction, an axis along the Y-direction, and/or an axis along the Z-direction. The alignment image of the stage 110 with the tilt error may comprise regions having different degrees of blurring.

After the comparison of the aligning image to the corresponding reference image, if no position shift is detected in the X-direction, the Y-direction and the Z-direction from the alignment images, the stage 110 is determined to have no position drift, and the method 400 proceeds to step S412. In step S412, an alignment operation is performed on the specimen 300.

If one of the alignment images includes a position shift in the X-direction, a position shift in the Y-direction, or a position shift in Z-direction, the stage 110 is determined to have a position drift, and the method 400 proceeds to step S408. In step S408, a health status of the stage 110 is determined. The health status of the stage 110 may be estimated based on the position shift of the stage 110 in different directions. In some embodiments, the processor 210 performs comparison operations to estimate the health status of the stage 110.

In some embodiments, the processor 210 is configured to compare the position shift in the X-direction with a first reference position. After the comparison, a first difference between the position shift in the X-direction and the first reference position is determined. The processor 210 is further configured to compare the first difference to a first threshold. If the first difference is equal to or greater than the first threshold, the stage 110 is determined to be unhealthy, and the method 400 proceeds to step S416, in which an alarm signal is issued to inform an operator that the stage 110 is unhealthy. The stage 110 may fail to accurately align the specimen 300 when the stage is determined to be unhealthy. The inspection of the specimen 300 may be terminated such that the specimen 300 is unloaded from the stage 110 when the stage is determined to be unhealthy.

The health estimation step further includes calculating a second difference between the position shift in the Y-direction with a second reference position and comparing the second difference to a second threshold. If the second difference is equal to greater than the second threshold, the stage 110 is determined to be unhealthy, and the method 400 proceeds to step S416 to issue the alarm signal. The health estimation step further includes calculating a third difference between the position shift in the Z-direction with a third reference position and comparing the third difference to a third threshold. If the third difference is equal to greater than the third threshold, the stage 110 is determined to be unhealthy, and the method 400 proceeds to step S416 to issue the alarm signal. In some embodiments, the stage 110 is determined to be healthy when the first difference is less than the first threshold, the second difference is less than the second threshold, and the third difference is less than the third threshold. The first target position, the second target position, and the third target position are collectively referred to as a reference position of the stage 110.

Subsequently, the method 400 proceeds to step S410, in which a stage calibration operation is performed to compensate for the position drift of the stage 110. During the stage calibration operation, the processor 210 is configured to generate calibration data including the position shift in the X-direction, the position shift in the Y-direction, and the position shift in the Z-direction. The processor 210 may transmit the calibration data to the driving mechanism 200. The driving mechanism 200 moves the stage 110 in accordance with the calibration data to compensate for the position drift of the stage 110. The detector 130 may capture images of the alignment marks 212a and 212b to check the position drift of stage 110 after undergoing the calibration are compensated to within a predetermined first tolerance. The stage calibration operation may be iteratively performed until the position drift is compensated to within the first tolerance. The first tolerance can allow for less precision in alignment during calibration, but still maintaining the stability of the specimen 300. The stage calibration operation may be performed to reduce or eliminate the position drift of the stage 110.

The method 400 continues with step S412, in which an alignment operation is performed on the specimen 300. The alignment operation may include a coarse alignment operation S4122 and a fine alignment S41224. In some embodiments, the specimen 300 includes one or more alignment marks, such as the alignment mark 302 shown in FIGS. 1 and 2. The coarse alignment operation S4122 may be achieved by identifying the alignment mark 302. The coarse alignment operation S4122 is performed for an imaging effect, such as focusing. During the coarse alignment operation S4122, the detector 130 captures an image of the alignment mark 302, and the processor 210 is configured to determine whether the image is in focus. If one of the images of the alignment mark 302 on the specimen 300 to be inspected is out of focus, the processor 210 will generate transmit a calibration data to the driving mechanism 200 based on the captured image. The driving mechanism 200 may be configured to adjust a distance between the specimen 300 and the detector 130, i.e., the distance in the Z-direction. The coarse alignment operation S4122 may be repeated until the image of the alignment mark 302 is in focus. If the image of the alignment mark 302 on the specimen 300 to be inspected is in focus, the coarse alignment operation S4122 is completed, and the operation proceeds to the fine alignment operation S4124.

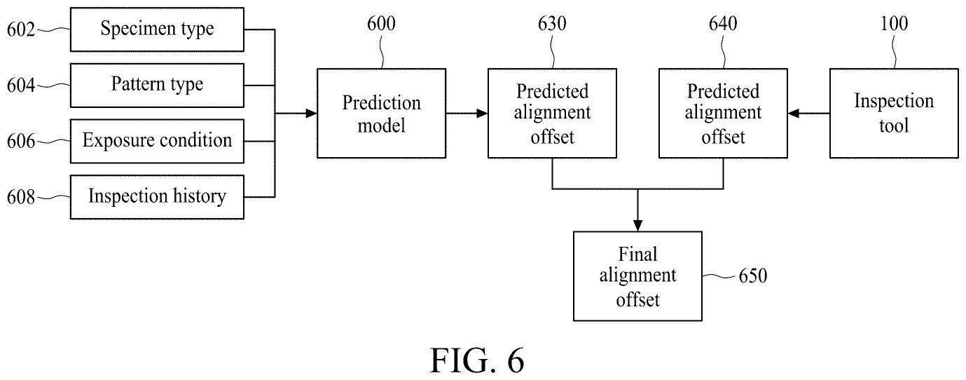

FIG. 6 is a schematic block diagram of generating a predicted alignment offset 630, a measured alignment offset 640, and a final alignment offset 650 during the fine alignment operation S4124, in accordance with some embodiments of the present disclosure. Referring to FIG. 6, in some embodiments, the fine alignment operation S4124 is performed to position the specimen 300 according to a predicted alignment offset 630 and a measured alignment offset 640. The predicted alignment offset 630 is obtained from a prediction model 600. Referring to FIGS. 1 and 6, the prediction model 600 may be executed on the processor 210. The prediction model 600 includes a well-trained machine learning model that is configured with a predetermined model structure and associated model parameters. When the prediction model 600 is a well-trained model, it can be utilized to predict a set of alignment offsets serving as output data given a set of input data. In the present disclosure, a parameter set associated with the specimen 300 serves as the input data of the prediction model. The parameter set may include, for example, a specimen type 602 (e.g., binary, phase shift mask (PSM), attenuated PSM, etc.), a pattern type 604 (e.g., a pattern of conductive lines, a pattern of diffusion regions, etc.), an exposure condition 606, and an inspection history 608. The exposure condition may include, but are not limited to, number of exposures, the exposure time, the wavelength of radiation used in a photolithography tool, the numerical aperture (NA) of the photolithography tool, the coherence value of the photolithography tool, the defocus, the exposure level, substrate conditions, and possibly imperfections of the photolithography tool such as aberrations or flare. The inspection history 608 may include information of the images of the specimen 300 in historic inspection tasks.

The model parameters of the prediction model 600 may be trained before the prediction model 600 is used to perform the prediction task. In some embodiments, the prediction model 600 is configured to train the values of the weights in the prediction model 600 that include information on specimen variations in different inspection tasks under different conditions and stage calibration data associated with the variations, and such information may be beneficial in predicting actual alignment offsets of the specimen 300 to be inspected. For example, an unused specimen is in an undistorted condition. The radiation used in a photolithography tool tends to heat the specimen, thus causing the specimen to expand and become thermally distorted. The actual location of the alignment mark 302 may be offset by a noticeable amount from a normal or previous alignment location due to such thermal expansion of the specimen 300, and therefore the prediction of the alignment offset may need to be tracked to facilitate tracking of the alignment mark 302.

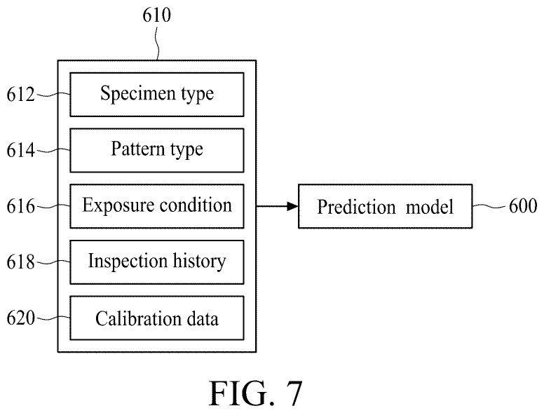

FIG. 7 is a schematic block diagram of training a prediction model, in accordance with some embodiments of the present disclosure. Referring to FIG. 7, the prediction model 600 may be trained based on input training data 610. The input training data 610 may include, for example, specimen type 612, pattern type 614, exposure condition 616, inspection history 618, and calibration data 620. The calibration data 620 may be used as ideal alignment offset for training the prediction model 600. The training data 610 is used as input at the training stage and the information on specimen variations and the stage calibration data are learned, trained and saved in the model parameters of the prediction model 600.

The parameter set associated with the specimen 300 are calculated in the prediction model 640 based on well-trained model parameters that may be provided from a training database 620. The prediction model 600 may include an artificial neural network (ANN) including an input layer, an output layer and a plurality of hidden layers. Each of the input layer, the output layer and the hidden layers has a plurality of nodes to form an interconnected network with corresponding weights. Those weights may also be referred to as model parameters configured to be trained using the aforementioned parameter set and the calibration data until these weights converges. At this point, the prediction model 600 with the convergent weights is referred to as a well-trained model 600 to predict the alignment offset.

Referring again to FIGS. 1 and 6, the measured alignment offset may be obtained from the inspection tool 100. For example, the detector 130 captures an image of the alignment mark 302, and the processor 210 is configured to determine whether the alignment mark 302 is placed at a target position. The processor 210 may be configured to compare the captured image, by the detector 130, with a default image that is already stored in the storage medium 220 to generate the measured alignment offset.

The processor 210 is further configured to generate the final alignment offset 650 based on the predicted alignment offset 630 and the measured alignment offset 640, in order to align the specimen 300 with improved accuracy. The final alignment offset 650 may include a first compensation value for calibrating the X-direction offset and a second compensation value for calibrating the Y-direction offset. The first compensation value may be generated based on a difference between a post-coarse alignment position of the alignment mark 302 and the target position of the alignment mark 302 in the X-direction. The second compensation value may be generated based on a difference between the post-coarse alignment position of the alignment mark 302 and the target position of the stage 110 in the Y-direction. The processor 210 may generate instructions for calibrating the position of the stage 110 based on the compensation parameter set and transmit the instructions to the driving mechanism 200. The driving mechanism 200 is configured to move the stage 110, and thus the specimen 300, towards the target position according to the instructions.

After the fine alignment operation S4124, the inspection system 10 may performed an alignment check operation to determine whether an alignment offset between a current position of the alignment mark 302 after undergoing the fine alignment operation and a target position of the second alignment mark 302 is within a second tolerance. The second tolerance can allow for less precision in alignment during inspection, but still maintaining the inspection of the specimen 300 at a high quality. In the alignment check operation, the detector 130 acquires an image of the alignment mark 302 on the specimen 300. The processes 210 compares the captured image with the default image. If the determination is negative (i.e., if the alignment offset greater than the second tolerance), the fine alignment is again perform. The fine alignment may be repeated until the alignment offset is less than the second tolerance. If the determination is positive (i.e., if the alignment offset is less than the second tolerance), the method 400 proceeds to step S414.

In step S414, an inspection operation is performed on the specimen 300 to detect defects. During the inspection operation, the detector 130 may capture one or more images of the specimen 300. The processor 210 may be configured to process the images to inspect the specimen 300 for quality defects, for example by applying an automated optical inspection algorithm on the plurality of images.

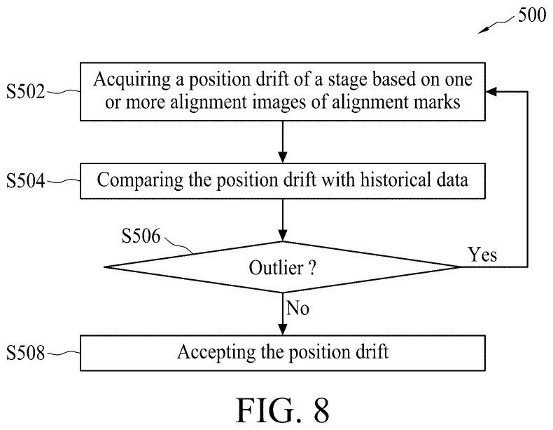

In some embodiments, after obtaining the positon drift of the stage 110 (e.g., the position shift in the X-direction, the position shift in the Y-direction, and the position shift in Z-direction of the alignment image) the processor 210 may determine whether the position drift is an outlier. FIG. 8 is a flowchart of a method of determining the position drift for calibrating a stage is an acceptable position drift, in accordance with some embodiments of the present disclosure. The method 500 includes a step S502 of acquiring a position drift of a stage, a step S504 of comparing the position drift with historical data, a step S506 of determining whether the position drift is an outlier, and a step S508 of accepting the position drift. The method may further be applied to determine an alignment offset of the alignment mark 302 is an outlier.

The following describes the method 500 using the above-mentioned inspection system 10. Referring to FIGS. 1, 2 and 8, the method 500 can begin at step S502, in which a position drift of a stage 110 is acquired. The position drift of the stage 110 may be acquired based on one or more alignment images of alignment marks 112a and 112b on the stage 110. The alignment images may be acquired by a detector 130. The detector 130 may transmit the alignment images to a processor 210 coupled thereto.

The method 500 then proceeds to step S504, in which the position drift is compared to historical data. The historical data may be the data stored in a storage medium 220. The historical data may include historical position drifts that are collected from a previous inspection results.

Subsequently, the method 500 proceeds to a determination step S506. In step S506, it is determined whether the position drift is an outlier. The processor 210 is configured to determine whether the position drift is an outlier by comparing the position drift to the historical position drifts. In some embodiments, the processor 210 may determine the position drift to be the outlier when the position drift is out of a range determined by the historical position drifts. If the position drift is determined to be the outlier, the method 500 returns to step S502; otherwise, if the position drift is determined to be within the range determined by the historical position drifts, the position drift is determined as an accepting position drift and may be used in the stage calibration operation.

In accordance with some embodiments of the present disclosure, an inspection method includes steps of placing a specimen on a stage, wherein the stage comprises a plurality of alignment marks; capturing a first image of the alignment marks; determining a position drift between a current position of the stage and a reference position of the stage based on the first image; compensating for the position drift between the current position of the stage and the reference position of the stage; and performing an inspection operation on the specimen in response to the position drift being less than a first tolerance.

In accordance with some embodiments of the present disclosure, an inspection method includes steps of placing a specimen on a stage, wherein the stage comprises a plurality of first alignment marks; capturing an image of the first alignment marks; determining whether the stage has a position drift based on the image; moving the stage in response to the stage has the position drift; and performing an inspection on the specimen in response to the position drift being less than a tolerance.

In accordance with some embodiments of the present disclosure, an inspection system includes a stage having a plurality of alignment marks; a detector over the stage; an illumination source configured to generate a radiation; a processor coupled to the stage and the detector; and a lens assembly configured to direct the radiation from the illumination source to the stage and to direct radiation reflected by the plurality of alignment marks to the detector. The processor is configured to determine whether the stage has a position drift based on an image of the plurality of alignment marks captured by the detector.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An inspection method, comprising:
placing an specimen on a stage, wherein the stage comprises a plurality of first alignment marks;
capturing a first image of the first alignment marks;
determining a position drift between a current position of the stage and a reference position of the stage based on the first image;
compensating for the position drift between the current position of the stage and the reference position of the stage; and
performing an inspection operation on the specimen in response to the position drift being less than a first tolerance.

2. The method of claim 1, further comprising:
determining a health status of the stage based on the position drift between the current position of the stage and the reference position of the stage.

3. The method of claim 2, further comprising:
issuing an alarm signal in response to the stage being determined to be unhealthy.

4. The method of claim 1, wherein one of the first alignment marks comprises a cross-shaped pattern and another of the first alignment marks comprises a line-and-space pattern.

5. The method of claim 1, wherein the first alignment marks are diagonally disposed with respect to each other from a top-view perspective.

6. The method of claim 1, further comprising, prior to the inspection operation on the specimen, performing an alignment operation on the specimen.

7. The method of claim 6, wherein the alignment operation comprises:
performing a coarse alignment operation to identify a second alignment mark on the specimen; and
performing a fine alignment operation to compensate for a final alignment offset between a current position of the second alignment mark and a target position of the second alignment mark,
wherein the inspection operation on the specimen is performed in response the final alignment offset being less than a second tolerance different from the first tolerance.

8. The method of claim 7, wherein the coarse alignment operation is completed when an image of the second alignment mark on the specimen is in focus.

9. The method of claim 7, wherein the performing of the fine alignment operation to compensate for the final alignment offset between the current position of the second alignment mark and the target position of the second alignment mark comprises:
determining a predicted alignment offset associated with the specimen based on a prediction model.

10. The method of claim 9, wherein the performing of the fine alignment operation to compensate for the final alignment offset between the current position of the second alignment mark and the target position of the second alignment mark further comprises:
capturing a second image of the second alignment mark on the specimen;
determining a measured alignment offset between the current position of the second alignment mark and the target position of the second alignment mark based on the second image; and
generating the final alignment offset based on the measured alignment offset and the predicted alignment offset.

11. The method of claim 9, further comprising performing a training on the prediction model using historical data including at least one of a specimen type, a pattern type, an exposure condition, an inspection history and calibration data of used specimens.

12. An inspection method, comprising:
placing a specimen on a stage, wherein the stage comprises a plurality of first alignment marks;
capturing an image of the plurality of first alignment marks;
determining whether the stage has a position drift based on the image;
moving the stage in response to the stage having the position drift; and
performing an inspection on the specimen in response to the position drift being less than a tolerance.

13. The method of claim 12, wherein the determination of whether the stage has the position drift based on the image comprises:
comparing the image with a reference image; and
identifying the position drift between the image and the reference image.

14. The method of claim 12, further comprising, prior to the performing of the inspection on the specimen, performing an alignment operation on the specimen to position the specimen by determining a position of a second alignment mark on the specimen.

15. The method of claim 12, further comprising:
determining a condition of the stage; and
issuing an alarm signal when the stage is unhealthy.

16. The method of claim 15, wherein the stage is determined to be unhealthy in response to the position drift being greater than a threshold.

17. The method of claim 12, wherein one of the plurality of first alignment marks comprises a first pattern for identifying a mapping error of the stage in a horizontal plane, and another of the first alignment marks comprises a second pattern for identifying a focus error.

18. An inspection system, comprising:
a stage having a plurality of alignment marks;
a detector over the stage;
an illumination source configured to generate a radiation;
a processor coupled to the stage and the detector; and
a lens assembly configured to direct the radiation from the illumination source to the stage and to direct radiation reflected by the plurality of alignment marks to the detector,
wherein the processor is configured to determine whether the stage has a position drift based on an image of the plurality of alignment marks captured by the detector.

19. The inspection system of claim 18, wherein the alignment marks are diagonally disposed with respect to each other from a top-view perspective.

20. The inspection system of claim 18, wherein one of the alignment marks comprises a cross-shaped pattern and another of the alignment marks comprises a line-and-space pattern.
